(19) United States
(12) Patent Application Publication
(10) Pub. No.: US 2012/0054491 A1
(43) Pub. Date: Mar. 1, 2012

(54) RE-AUTHENTICATION IN CLIENT-SERVER COMMUNICATIONS

(76) Inventor: PETER JOHN TIPPETT, North Vancouver (CA)

(21) Appl. No.: 12/871,944

(22) Filed: Aug. 31, 2010

(51) Int. Cl. H04L 9/32

(52) U.S. Cl. 713/168

(57) ABSTRACT

Various embodiments of systems and methods for re-authentication in client-server communications are described herein. A composite key is constructed by cryptographic hashing of a master key and a user key. A payload is constructed using a user identifier and a validity parameter. The payload is then encrypted using the composite key. A token is constructed by combining the encrypted payload, the user identifier, and a master key identifier. The constructed token is transmitted to the client system. To establish a subsequent session, the token is received at the server from the client system for re-authentication. The server validates the received token and establishes the subsequent session if the token is validated.

### FIELD

The field relates generally to client-server communication protocols. More particularly, the field is related to direct re-authentication of a user of a client system.

### BACKGROUND

In client-server communications, authentication can be considered as a primary security feature. A user of a client system authenticates to a server by providing credentials such as a username and a password. Depending on the relation between the client and the server, authentication patterns include direct authentication and brokered authentication. Direct authentication can be performed when the client and the server are in a trusted relationship. In direct authentication, the client and the server directly exchange information and validate credentials without a third party between them. If the client and the server do not share a direct trust relationship, a broker can be used to perform authentication.

In direct authentication, after a user of a client system is initially authenticated by the server, a token can be generated for the authenticated user to allow re-authentication for some period of time. The token represents the authenticated user. Initial authentication may last for a single session. By using the token, the authenticated user can re-authenticate with the server and establish a new session or stay connected to an existing session. Therefore, the user may not be required to provide credentials again for re-authentication.

Typically, the server generates the token for re-authentication by persisting or writing information to a disk or a database at the server side. The server then transmits the token to the client. The persistence of information at the server should be completed before the token is transmitted to the user. However, this persistence of information can be slow and become a scalability concern because persistence needs exclusive access to a memory resource such as a disk at the server side. Therefore, re-authenticating without persisting or writing the token at the server side would be desirable.

### SUMMARY

Various embodiments of systems and methods for re-authentication in client-server communications are described herein. Initially, at least one token is constructed at the server. A composite key is constructed by cryptographic hashing of a master key and a user key. A payload is constructed using a user identifier and a validity parameter. The payload is then encrypted using the composite key. The token is constructed by combining the encrypted payload, the user identifier, and a master key identifier. The constructed token is then transmitted to the client system without persisting the token in the server. The token can be saved in the client system. The client system can use this token for re-authentication. To establish a subsequent session, the token is received at the server from the client system for re-authentication. The server validates the received token and establishes the subsequent session if the token is validated.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a client-server environment.

FIG. 2 is a flow diagram illustrating a re-authentication method according to one embodiment.

FIG. 3 is a flow diagram illustrating token construction according to one embodiment.

FIG. 4 is a flow diagram illustrating token validation according to one embodiment.

FIG. 5 is a flow diagram illustrating token construction according to another embodiment.

FIG. 6 is a block diagram illustrating client-server communications according to one embodiment.

FIG. 7 is a block diagram of a server according to one embodiment.

FIG. 8 is a block diagram of an exemplary computer system according to one embodiment002E

### DETAILED DESCRIPTION

Embodiments of techniques for re-authentication in client-server communications are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

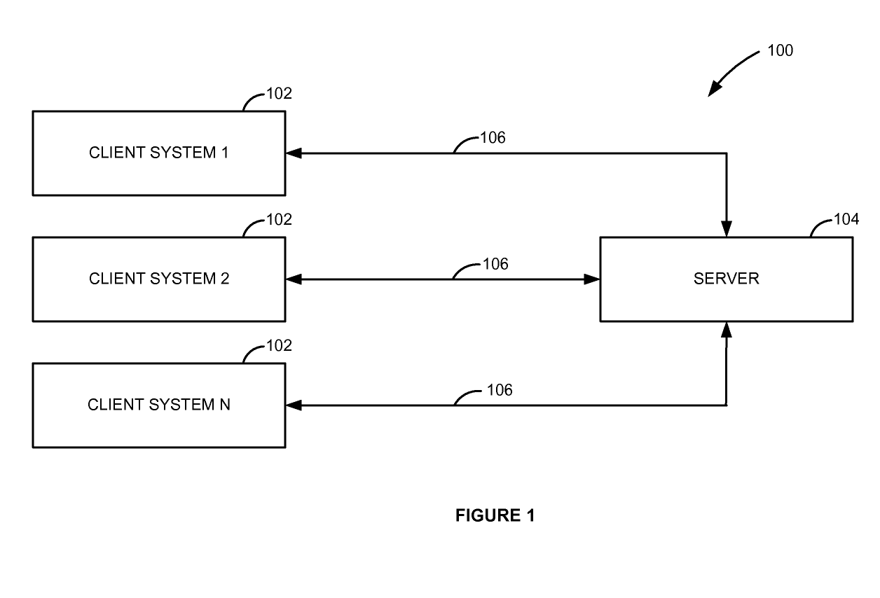

FIG. 1 illustrates a client-server environment 100 in which the client system 102 trusts the server system 104 and authenticates and re-authenticates with the server 104 in order to use services that the server 104 provides. Communications between the client system and the server should be secured to prevent sniffing, Man-In-The-Middle attacks, or replay attacks. Cryptographic protocols such as Secure Socket layer (SSL) can be used for secure communications between the client system and the server. The client system 102 and the server 104 can therefore directly exchange information and validate credentials without a third party between them. The server 104 supports the concept of a user account. A user account is confidential and each user account is owned by one real user. Each user account has associated credentials such as a username and a password. A user of a client system 102 authenticates to the server 104 by providing credentials via a secured communication channel 106 such as the Internet.

The server 104 checks the credentials and authenticates the user if the credentials are correct.

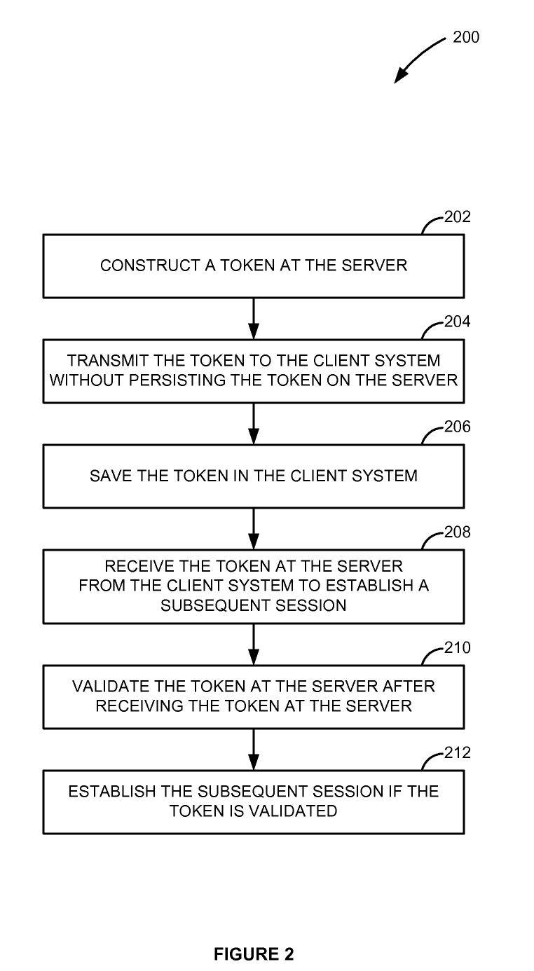

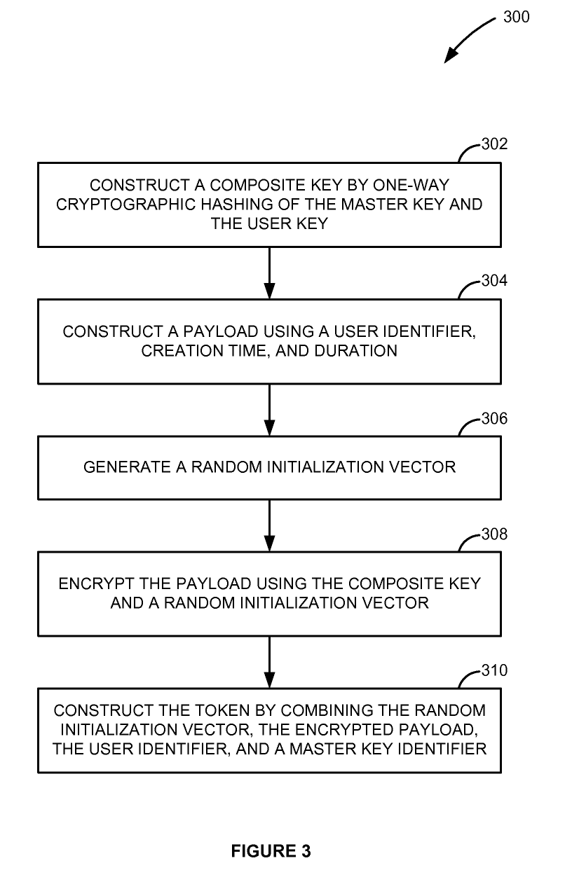

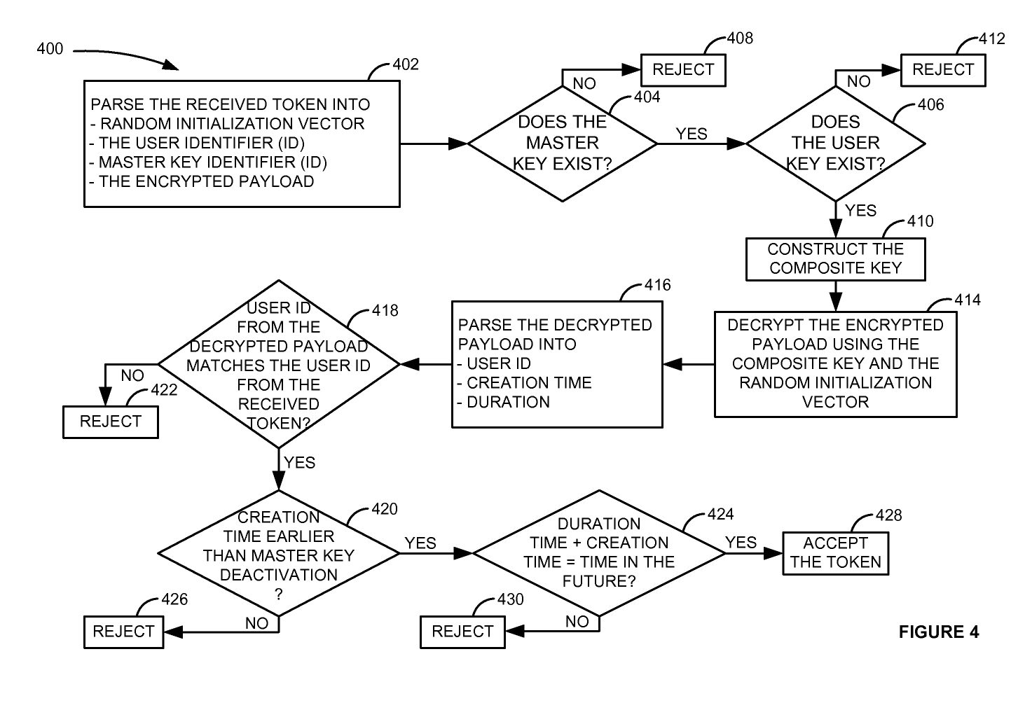

FIG. 2 illustrates an embodiment of a re-authentication method 200 in a client-server environment. At 202, a token is constructed at the server. An embodiment of token constructing process is described in reference to FIG. 3. At 204, the constructed token is transmitted to the client system without persisting or writing the token on the server. The client system receives and saves the token at 206. This token can be used by the client system for re-authentication with the server to establish a subsequent session without the need for re-sending the credentials. A subsequent session can be a new session or continuation of an existing session. The client system sends the token to the server for re-authentication. The token is received at the server from the client system at 208. The server validates the token at 210. An embodiment of token validation process is described in reference to FIG. 4. If the token is validated, the subsequent session is established at 212.

FIG. 3 illustrates an embodiment 300 of token construction. The token is constructed in the server. At 302, a composite key is generated by cryptographic hashing of a user key and a master key. Each user account of a user includes a corresponding persisted representation in the server. This persisted representation can be referred to as a user object, which can include any user-specific information such as user preferences, etc. The user object has a user identifier, which is a system-unique identifier for the user. Each user object also has a designated random user key. The user key should have high level of confidentiality and should not be provided to the user. In one embodiment, the user key is hidden from the user and an administrator. The user object concept can be generalized to a combination of a number of authorization entities. In some cases the user object may not exist in the system. But another object (or objects) can exist with which the user is associated, for example, a set of groups that the user was part of Each of those objects can have a key and all such keys can be hashed together to produce the user key.

A master key is a key that is available internal to the system (e.g. server system) for use in encryption and decryption. In one embodiment, lifecycle for master keys can be implemented by deactivating an active master key and activating a new master key. Deactivated master keys can be used for decryption, but not for encryption. Deactivated master keys can carry a timestamp indicating the time of deactivation. The master key also has a system-unique identifier that is referred to as a master key identifier.

In one embodiment, a one-way cryptographic hashing is performed on the combination of the user key and the master key to generate the composite key at 302. One-way cryptographic hash algorithms mathematically transform data of arbitrary length into a fixed-length string. The mathematical properties of the transformation ensure that the reversion of the hashing is computationally hard and that similar data yield dissimilar hash values. The output of the one-way hash algorithm on the combination of the user key and the master key is the composite key (i.e. a hash value or a message digest). Examples of one-way cryptographic hashing algorithms include Secure Hash Algorithms (SHA). In one embodiment, a Secure Hash Algorithm (SHA) with a digest size of 256 (SHA-256) can be used to generate the composite key.

At 304, a payload is constructed using the user identifier and a validity parameter. In one embodiment, the validity parameter includes a creation time of the token and duration of validity of the token. The payload is constructed by combining the user identifier, the creation time, and the duration. The constructed payload can be represented as below:

Payload=(<user identifier><creation time><duration>)

At 306, an initialization vector is generated randomly. The random initialization vector is a non-secret parameter to an encryption algorithm that helps protect a sensitive key from being discovered. The initialization vector is also required to be passed to the AES-128 decryption algorithm when the cipher text (e.g. encrypted payload) is to be decrypted.

The payload is then encrypted at 308. In one embodiment, encryption is performed using an Advanced Encryption Standard (AES) process. AES was announced by National Institute of Standards and Technology (NIST) as U.S. Federal Information Processing Standards Publications (FIPS PUB 197) on Nov. 26, 2001. The Advanced Encryption Standard (AES) specifies a FIPS-approved cryptographic algorithm. The AES algorithm is a symmetric block cipher that can encrypt (encipher) and decrypt (decipher) information. Encryption converts data to cipher text and decrypting the cipher text converts the data back into its original form, called plaintext. The AES algorithm is capable of using cryptographic keys of 128, 192, and 256 bits to encrypt and decrypt data in blocks of 128 bits.

In one embodiment, an AES-128 encryption/decryption algorithm is used. The input and output for the AES algorithm each consist of sequences of 128 bits (digits with values of 0 or 1). These sequences will sometimes be referred to as blocks and the number of bits they contain will be referred to as their length. A cipher key for the AES 128 algorithm is a sequence of 128 bits. The AES algorithm takes an input, a cipher key, and an initialization vector and generates an encrypted output.

In one embodiment, the payload is encrypted using the composite key in conjunction with the generated random initialization vector. Specifically, the AES-128 algorithm is provided with three parameters, namely, the payload that is to be encrypted, the composite key as the cipher key, and the random initialization vector. The AES-128 algorithm then generates an encrypted payload as the output.

At 310, the token is constructed by combining the random initialization vector, the encrypted payload, the user identifier, and a master key identifier. The initialization vector is pre-pended to the encrypted payload along with the user identifier and the master key identifier to ensure that it will be known when decryption occurs during token validation. The constructed token can be represented as below:

Token=(<random initialization vector ><encrypted payload><user id><master key id>)

FIG. 4 illustrates an embodiment 400 of token validation. Token validation takes place in the server after the token is received from the client system. At 402, the token is parsed into the random initialization vector, the encrypted payload, the user identifier, and the master key identifier. As described previously, the master key identifier is associated with a master key. Existence of the master key with reference to the master key identifier is verified at 404. If the master key exists, the validation process moves to step 406. If the master key does not exist, the token is rejected at 408.

At 406, the existence of the user key with reference to the user identifier obtained from parsing the token is checked. As described previously, the user object has a user identifier and each user object also has a designated random user key. Therefore, a user key has a reference to a user identifier. If the user key with reference to the user identifier is found, then the validation process moves to 410. If the user key does not exist, then the token is rejected at 412.

The master key and the user key are used to generate the composite key at 410 by a one-way hashing algorithm (e.g. SHA 256). This one-way hashing step mimics the one-way hashing performed in the step 302 of token construction process (FIG. 3). At 414 the composite key generated at step 410 is used in conjunction with the initialization vector parsed at step 402 to decrypt the encrypted payload also parsed at 402. In one embodiment, an AES-128 encryption/decryption algorithm is used to decrypt the encrypted payload. The encrypted payload is provided as the cipher text to the AES-128 decryption algorithm, the composite key (generated at 410) is provided as the cipher key to the AES-128 decryption algorithm, and the initialization vector (parsed at 402) is provided as the initialization vector to the AES-128 decryption algorithm. The AES-128 decryption algorithm then generates a decrypted payload as the output.

At 416, the decrypted payload is parsed into the user identifier and the validation parameter. As described previously, in one embodiment, the validation parameter includes a creation time of the token and duration of validity of the token. Therefore, parsing the decrypted payload yields the user identifier, the creation time of the token, and the duration of validity of the token.

At 418, the user identifier obtained from parsing the decrypted payload (i.e. at 416) is compared with the user identifier obtained from the parsing the token (i.e. at 402). If the user identifiers from the decrypted payload and the received token are the same, the validation process moves to step 420. If the user identifiers from the decrypted payload and the received token do not match, the token is rejected at 422.

As described previously, lifecycle for master keys can be implemented by deactivating an active master key and activating a new master key. So each master key has an activation time and a deactivation time. Since there are two validity parameters, i.e. the creation time and the duration, validation of the validity parameters includes two steps. At 420, master key validation is performed to check whether the master key (that is obtained at 404 as part of validating the master key id obtained at 402) is still active. In one embodiment, the creation time of the token is checked against the deactivation time of the master key. If the creation time of the token is earlier than the deactivation time of the master key, the validation process moves to 424. The token is rejected at 426 if the creation time of the token is later than the deactivation time of the master key.

At 424, the duration of validity of the token is checked. If the sum of the duration and the creation time yields a time in future, the token is accepted at 428. The duration can also be validated against a system-wide maximum token duration limit. This makes the tokens invalid after a specified duration limit. The token is rejected at 430 if the sum of the duration and the creation time yields a time in the past. Token acceptance step 428 completes the validation of the token.

The token validation method includes multiple validation steps to ensure the validity of the token. Steps 404 and 406 ensure the existence of necessary keys, i.e. the user key and the master key. Step 418 ensures the integrity of the token and the payload with respect to the user identifier. Step 418 also ensures that the decryption was successful. Step 420 ensures that an old master key is not cracked and being used to generate new tokens. This limits the vulnerability of cracking a master key to only the time period during which a given master key is active. Step 424 ensures that the token had not expired.

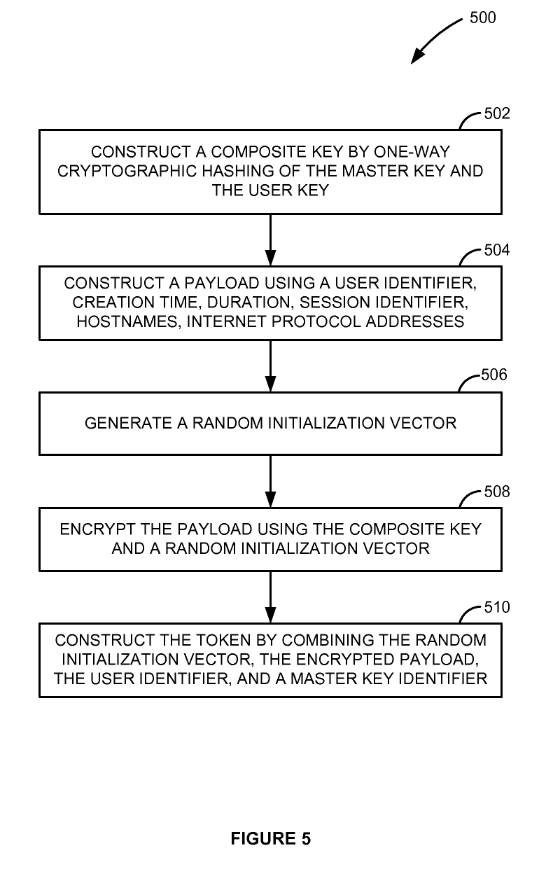

FIG. 5 illustrates another embodiment 500 of token construction. At 502, a composite key is generated by one-way cryptographic hashing of a user key and a master key using a Secure Hash Algorithm (SHA-256). At 504, a payload is constructed using the user identifier and a validity parameter. In this embodiment, the validity parameter includes a creation time of the token, duration of validity of the token, a session identifier, a list of hostnames, and a list of Internet Protocol addresses. The payload is constructed by combining the user identifier, the creation time, the duration, the session identifier, the hostnames, and the IP addresses. In one embodiment, the validity parameter can further include a restriction entry that limits how the token can be used. For example, the restriction entry can specify that the token can be used to access only certain resources.

At 506, an initialization vector is generated randomly. The payload is then encrypted at 508 using an Advanced Encryption Standard 128 (AES-128) encryption/decryption algorithm that uses the payload, the composite key and the random initialization vector as parameters. The AES-128 algorithm then generates an encrypted payload as the output. At 510, the token is constructed by combining the random initialization vector, the encrypted payload, the user identifier, and a master key identifier. The validation process for the token constructed according to this embodiment is similar to the validation process described in reference to FIG. 4, with the addition of steps to check the existence of a session based on the session identifier, the existence of a hostname in the list of hostnames, and the existence of an IP address in the list of the IP addresses.

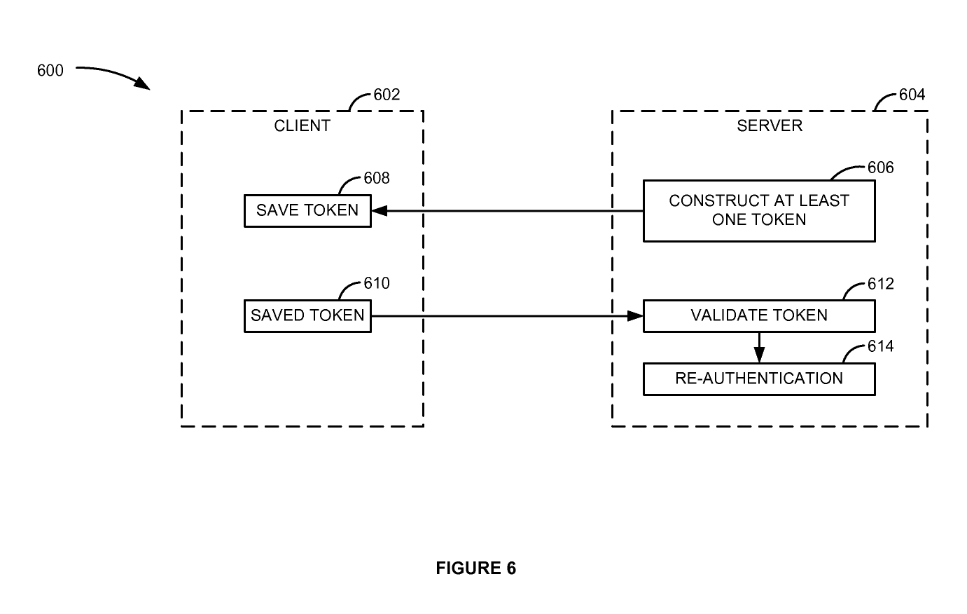

FIG. 6 is a block diagram 600 illustrating communications between a client 602 and a server 604. The client 602-server 604 framework implements a lifecycle for master keys by deactivating an active master key and activating a new master key after a prescribed duration. Master keys are available for encryption and encryption within the system and are only exposed outside the system to very special users, referred to as “Cryptographic Officers”. Also, the master key is subject to FIPS-approved key management (including key lifecycles and renewal capability). The client 602-server 604 framework also implements system-wide maximum token duration limit. The client 602-server 604 framework also provides a system-unique user identifier for each user object and a system-unique master key identifier.

The server 604 constructs at least one token at 606. Each token is constructed according to the token construction procedure described in FIG. 3 or FIG. 5. Tokens can be constructed for users who are logged-on. Tokens can also be constructed internally for users who have not logged on. For example, if a system wishes a service to do something on behalf of a user, then a token can be generated. This does not require that the user in question ever authenticates with the system.

The server 604 transmits the token to the client 602 without persisting or writing the token. The client 602 saves the token at 608. To establish a subsequent session, the client 602 uses the saved token 610 for re-authentication. The client 602 sends the saved token 610 to the server 604. The server 604 then validates the token at 612 according to the token validation procedure (as described in reference to FIG. 4). If the token is validated, the server 604 re-authenticates the user at 614. A subsequent session is then established. The number of re-authentications can be made dependent on validity parameters.

It can be noted that it is the client system that saves the token, not the server. Each time a client wants to re-authenticate, the client transmits the saved token to the server for validation. The server validates and establishes a subsequent session. The server generates token and validates token for re-authentication, but the server does not persist token on to any disk or memory on the server side.

The re-authentication method can also be applicable in case of multiple servers. If the tokens generated on one server are required by another server, the user object consisting of at least an identifier and the user key and master key object consisting of at least an identifier and the master key, and probably a deactivation timestamp should be shared between the servers.

Depending on the desired level of security, the user key can be destroyed when the user logs off and recreated in a next logon. Therefore, even if the user key is discerned or hacked, it may not possible to impersonate the user. In the multiple-server case, this requires coordinated re-keying to ensure continued interoperability.

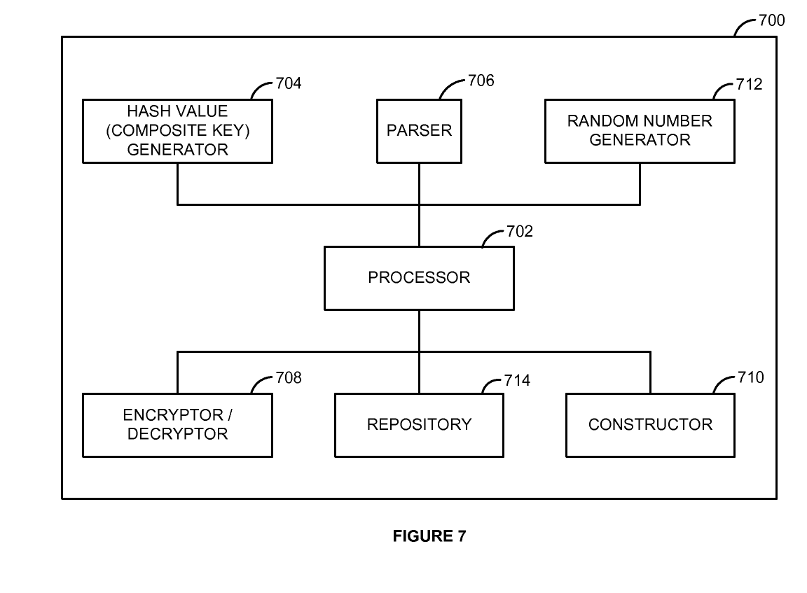

FIG. 7 illustrates a block diagram of a server 700 according to one embodiment. The server includes a processor 702, a hash value generator 704, a parser 706, an encryptor/decryptor 708, a constructor 710, a cryptographically secure random number generator 712, and a repository 714. The processor 702 coordinates with the hash value generator 704, the parser 706, the encryptor/decryptor 708, the constructor 710, the random number generator 712, and the repository 714 to construct a token according to the token construction process described in reference to FIG. 3 or 5 and validate the token according to the validation process described in described in reference to FIG. 4. The hash value generator 704 is based on a Secure Hash Algorithm (e.g. SHA-256) and constructs the composite key in the token construction process (i.e. at step 302 of FIG. 3). The hash value generator also constructs the composite key in the token validation process (i.e. at step 410 of FIG. 4).

The parser 706 parses the received token into the random initialization vector, the encrypted payload, the user identifier, and the master key identifier in the token validation process (i.e. at step 402 of FIG. 4). The parser 706 also parses the decrypted payload into the user identifier and the validation parameter in the token validation process (i.e. at step 416 of FIG. 4). The encryptor/decryptor 708 is based on AES-128 algorithm and is used to encrypt the payload in the token construction process (i.e. at step 306 of FIG. 3). The encryptor/decryptor 708 also decrypts the token in the token validation process (i.e. at step 414 of FIG. 4). The constructor 710 constructs the payload and the token in the token construction process (i.e. at steps 304 and 308 of FIG. 3). The random number generator 712 is used to generate initialization vectors. The master key and user objects are stored in the repository 714. The repository 714 is used to find the user key from the user identifier, the master key, and a deactivation time of the master key from the master key identifier. The other validation steps in the token validation process such as checking the existence of the user key, checking the existence of the master key, comparing the user identifier from the decrypted payload with the user identifier from the received token, and validating the validity parameters can be performed by the processor 702.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

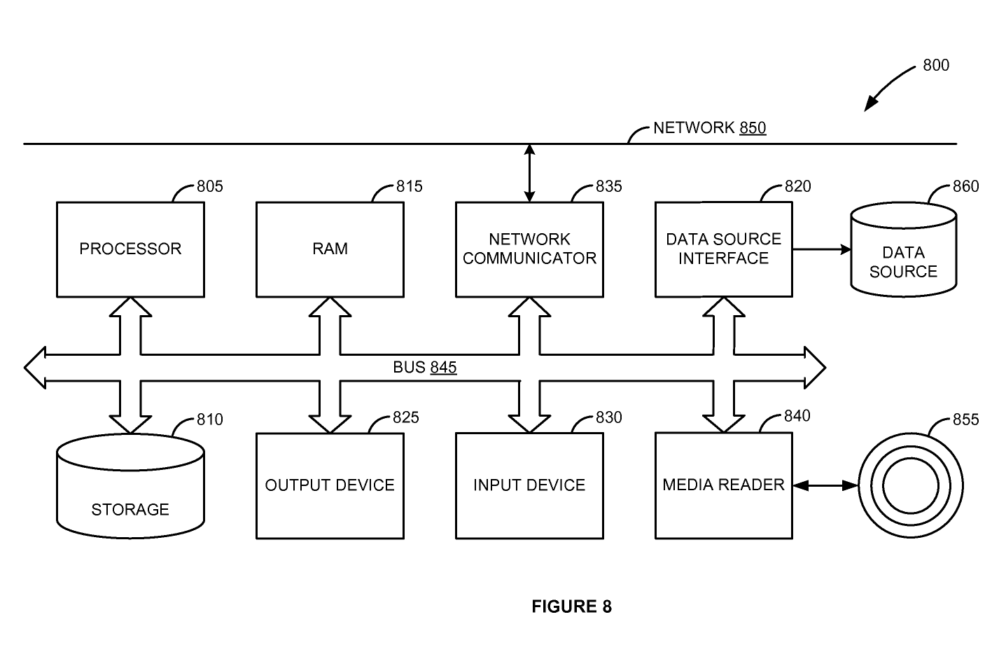

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
construct at least one token at the server, comprising:
construct a composite key by cryptographic hashing of a master key and a user key;
construct a payload using a user identifier and a validity parameter;
encrypt the payload using the composite key; and
construct the token by combining the encrypted payload, the user identifier, and a master key identifier;
after constructing the token, transmit the token to a client system;
receive the token at the server from the client system to establish a subsequent session;
after receiving the token at the server, validate the token at the server; and
establish the subsequent session if the token is validated.

2. The article of manufacture of claim 1, wherein the instructions to validate the token at the server, comprise instructions to:
check the existence of the master key with reference to the master key identifier;
check the existence of the user key with reference to the user identifier;
if the user key and the master key exist, constructing the composite key by combining the master key and the user key;
decrypt the encrypted payload using the composite key;
compare the user identifier from the decrypted payload with the user identifier from the received token; and
if the user identifier from the decrypted payload matches the user identifier from the received token, validate the validity parameter.

3. The article of manufacture of claim 2, wherein the validity parameter comprises a creation time and a duration of validity, and the instructions to validate the validity parameter comprise instructions to:
check if the creation time is earlier than a deactivation time of the master key;
if the creation time is earlier than a master key deactivation time, check if the sum of the duration and the creation time yields a time in future; and
accept the token if the sum of the duration and the creation time yields a time in future.

4. The article of manufacture of claim 2, wherein the validity parameter further comprises a session identifier, a hostname, an Internet Protocol address, or combinations thereof

5. The article of manufacture of claim 2, wherein the instructions to validate the token at the server, further comprises:
parse the received token into the user identifier, the master key identifier, and the encrypted payload; and
parse the decrypted payload into the user identifier and the validity parameter.

6. The article of manufacture of claim 1, further comprise instructions to: generate a random initialization vector and wherein:
the instructions to encrypt the payload using the composite key, further comprise instructions to: use the generated random initialization vector; and
the instructions to construct the token, comprise instructions to: construct the token by combining the random initialization vector, the encrypted payload, the user identifier, and the master key identifier.

7. The article of manufacture of claim 1, wherein the instructions to construct the composite key by cryptographic hashing of the master key and the user key, comprise instructions to:
construct the composite key by one-way cryptographic hashing of a combination of the master key and the user key.

8. The article of manufacture of claim 1, wherein the user key is associated with an account of a user and is hidden from the user, and the master key is a key that is available internal to a system for use in encryption and decryption.

9. A computerized method for re-authentication in a client-server environment, the method comprising:
constructing at least one token at the server, comprising:
constructing a composite key by cryptographic hashing of a master key and a user key;
constructing a payload using a user identifier and a validity parameter;
encrypting the payload using the composite key; and
constructing the token by combining the encrypted payload, the user identifier, and a master key identifier;
after constructing the token, transmitting the token to a client system;
receiving the token at the server from the client system to establish a subsequent session;
after receiving the token at the server, validating the token at the server; and
establishing the subsequent session if the token is validated.

10. The method of claim 9, wherein validating the token at the server, comprises:
checking the existence of the master key with reference to the master key identifier;
checking the existence of the user key with reference to the user identifier;
if the user key and the master key exist, constructing the composite key by combining the master key and the user key;
decrypting the encrypted payload using the composite key;
comparing the user identifier from the decrypted payload with the user identifier from the received token; and
if the user identifier from the decrypted payload matches the user identifier from the received token, validating the validity parameter.

11. The method of claim 10, wherein the validity parameter comprises a creation time and duration of validity and validating the validity parameter comprises:
checking if the creation time is earlier than a deactivation time of the master key;
if the creation time is earlier than a master key deactivation time, checking if the sum of the duration and the creation time yields a time in future; and
accepting the token if the sum of the duration and the creation time yields a time in future.

12. The method of claim 9, wherein the validity parameter further comprises a session identifier, a hostname, an Internet Protocol address, or combinations thereof

13. The method of claim 10, wherein validating the token at the server, further comprises:
parsing the received token into the user identifier, master key identifier, and the encrypted payload; and
parsing the decrypted payload into the user identifier and the validity parameter

14. The method of claim 9, further comprise instructions to: generate a random initialization vector and wherein:
encrypting the payload using the composite key, comprises: using the generated random initialization vector; and
constructing the token, comprises: constructing the token by combining the random initialization vector the encrypted payload, the user identifier, and the master key identifier.

15. The method of claim 9, wherein constructing the composite key by cryptographic hashing of the master key and the user key, comprises:
constructing the composite key by one-way cryptographic hashing of a combination of the master key and the user key.

16. The method of claim 9, wherein the user key is associated with an account of a user and is hidden from the user, and the master key is a key that is available internal to a system for use in encryption and decryption.

17. A computer system for re-authentication, comprising:
a computer memory to store program code; and
a processor to execute the program code to:
construct at least one token at the server, comprising:
construct a composite key by cryptographic hashing of a master key and a user key;
construct a payload using a user identifier and a validity parameter;
generate a random initialization vector;
encrypt the payload using the composite key and the random initialization vector; and
construct the token by combining the random initialization vector, the encrypted payload, the user identifier, a master key identifier;
after constructing the token, transmit the token to a client system;
receive the token at the server from the client system to establish a subsequent session;
after receiving the token at the server, validate the token at the server; and
establish the subsequent session if the token is validated.

18. The system of claim 17, wherein the program code to validate the token at the server, comprises program code to:
parse the received token into the user identifier, master key identifier, the encrypted payload, and the random initialization vector;
check the existence of the master key with reference to the master key identifier;
check the existence of the user key with reference to the user identifier;
if the user key and the master key exist, construct the composite key by combining the master key and the user key;
decrypt the encrypted payload using the composite key;
parse the decrypted payload into the user identifier and the validity parameter;
compare the user identifier from the decrypted payload with the user identifier from the received token; and
if the user identifier from the decrypted payload matches the user identifier from the received token, validate the validity parameter.

19. The system of claim 18, wherein the validity parameter comprises a creation time and duration of validity, and the program code to validate the validity parameter comprises:
check if the creation time is earlier than a deactivation time of the master key;
if the creation time is earlier than a master key deactivation time, check if the sum of the duration and the creation time yields a time in future; and
accept the token if the sum of the duration and the creation time yields a time in future.

20. The system of claim 18, wherein the validity parameter further comprises a session identifier, a hostname, an Internet Protocol address, or combinations thereof

21. The system of claim 17, wherein construct the composite key by cryptographic hashing of the master key and the user key, comprises:
construct the composite key by one-way cryptographic hashing of a combination of the master key and the user key.

22. The system of claim 17, wherein the user key is associated with an account of a user and is hidden from the user, and the master key is a key that is available internal to a system for use in encryption and decryption.
